(19) United States
(12) Patent Application Publication
(10) Pub. No.: US 2025/0145069 A1
(43) Pub. Date: May 8, 2025

(54) HEADREST SKIN MATERIAL AND HEADREST

(71) Applicant: TOKAI CHEMICAL INDUSTRIES, LTD., Gifu (JP)

(72) Inventor: Shinsuke Okada, Gifu (JP)

(73) Assignee: TOKAI CHEMICAL INDUSTRIES, LTD., Gifu (JP)

(21) Appl. No.: 19/014,239

(22) Filed: Jan. 9, 2025

Related U.S. Application Data
(63) Continuation of application No. PCT/JP2023/030545, filed on Aug. 24, 2023.

(30) Foreign Application Priority Data
Aug. 30, 2022 (JP) 2022-136709

(51) Int. Cl. B60N 2/80; B60N 2/58

(52) U.S. Cl. CPC B60N 2/80; B60N 2/5875; B60N 2/5883; B60N 2/5891; B60N 2002/899

(57) ABSTRACT

A headrest skin material includes a bottom from which a leg of a stay protrudes. The headrest skin material includes: a first skin piece, constituting the bottom; and a seal skin piece, attached to an inner surface of the first skin piece. The first skin piece includes: a first projecting piece, protruding inward of the headrest skin material; a pair of first insertion holes, through which the leg of the stay is inserted; a pair of first slits, extending from the pair of first insertion holes to a tip edge of the first projecting piece; and a first tongue piece, formed by the pair of first slits. The seal skin piece covers an area on the inner surface of the first skin piece that is wider than an area where the pair of first slits and the pair of first insertion holes are formed.

### CROSS-REFERENCE TO RELATED APPLICATION

This application is a continuation of PCT International Application No. PCT/JP2023/030545, filed on Aug. 24, 2023, which claims priority under 35 U.S.C § 119 (a) to Japanese Patent Application No. 2022-136709, filed on Aug. 30, 2022. Each of the above application(s) is hereby expressly incorporated by reference, in its entirety, into the present application.

### BACKGROUND

### Technical Field

The disclosure relates to a headrest skin material and a headrest.

### Related Art

Conventionally, a headrest attached to a vehicle seat includes a skin material sewn into a bag shape, foamed resin filled inside the skin material, and a metal stay arranged inside the skin material and protruding outside the skin material.

In the case where the stay is in the form of a single metal rod bent into, for example, a shape which can be drawn with one stroke, such as a U-shape, by inserting one end of the stay from one of a pair of stay holes formed in the skin material, and inserting the one end of the stay from the other stay hole to the outside of the skin material, a configuration can be achieved in which a middle part of the stay is arranged inside the skin material and both legs of the stay protrude outside the skin material. After the stay is attached to the skin material, foamed resin is injected from a raw material injection port for injecting foamed resin, and then the foamed resin is foamed and cured, thereby forming a headrest.

Recently, in some cases, a structure such as an electrical part, such as a metal member for reinforcement, a heater, or a speaker, may be attached to a portion of the stay that is arranged inside the skin material. In the case of a stay having such a configuration, since the structure cannot be inserted through a stay insertion hole, the stay cannot be arranged inside the skin material by the procedure mentioned above.

Accordingly, as described in Japanese Patent Laid-Open No. H9-56939, a technique has been considered in which a linear cut for inserting the stay is provided in the skin material, and a tongue piece is provided that covers and conceals the linear cut from the outside. According to the above technique, the stay and the structure are inserted into the inside of the skin material from the linear cut, then the linear cut is covered by the tongue piece from the outside, and foamed resin is injected from a raw material injection port with the linear cut covered by the tongue piece. Accordingly, the stay to which the structure is attached can be arranged inside a headrest.

However, according to the above technique, even if the linear cut is covered by the tongue piece from the outside, there is a risk that the foamed resin may leak from a gap between the linear cut and the tongue piece.

### SUMMARY

One aspect of the disclosure relates to a headrest skin material that is obtained by sewing multiple skin pieces and includes a bottom from which a leg of a stay protrudes. The multiple skin pieces include: a first skin piece, constituting the bottom; a second skin piece, arranged adjacent to the first skin piece; and a seal skin piece, attached to an inner surface of the first skin piece. A peripheral edge of the first skin piece and a peripheral edge of the second skin piece are configured in a state of being sewn together except for an injection port into which foamed resin is injected. The first skin piece includes: a first projecting piece, protruding inward of the headrest skin material from the injection port; a pair of first insertion holes, through which the leg of the stay is inserted; a pair of first slits, extending from the pair of first insertion holes to a tip edge of the first projecting piece; and a first tongue piece, formed by the pair of first slits. The second skin piece includes a second projecting piece protruding inward of the headrest skin material from the injection port and arranged to face the first projecting piece. The seal skin piece covers, from the inside of the first skin piece, an area on the inner surface of the first skin piece that is wider than an area where the pair of first slits and the pair of first insertion holes are formed. The seal skin piece is engaged at a position on the inner surface of the first skin piece outside the pair of first slits in a direction in which the pair of first slits are aligned. The seal skin piece includes: a pair of second insertion holes, provided at a position overlapping the pair of first insertion holes, through which the leg of the stay is inserted; a second slit, extending from the pair of second insertion holes and having a width smaller than a span dimension of the pair of first insertion holes; and a second tongue piece, formed by a hole edge of the pair of second insertion holes and the second slit.

Another aspect of the disclosure relates to a headrest including: the aforementioned headrest skin material; the stay, on which a structure is arranged at a portion arranged inside the headrest skin material, and through which the leg is inserted from the pair of first insertion holes and the pair of second insertion holes; and foamed resin, filled inside the headrest skin material.

### BRIEF DESCRIPTION OF THE DRAWINGS

FIG. 1 is a partially cut-away perspective view showing a headrest according to Embodiment 1.

FIG. 2 is a flowchart showing a manufacturing process of the headrest according to Embodiment 1.

FIG. 3 is a plan view showing a stay according to Embodiment 1.

FIG. 4A to FIG. 4C are plan views showing a first skin piece, a second skin piece, and a seal skin piece according to Embodiment 1.

FIG. 5 is a plan view showing a state in which the first skin piece and the seal skin piece are sewn together according to Embodiment 1.

FIG. 6 is a bottom view showing a headrest skin material according to Embodiment 1.

FIG. 7 is an enlarged cross-sectional view along line VII-VII in FIG. 6.

FIG. 8 is an enlarged cross-sectional view along line VIII-VIII in FIG. 6.

FIG. 9 is a bottom view showing a state in which a first tongue piece of the first skin piece and a second tongue piece of the seal skin piece are opened in a process indicated in S5 of the flowchart in FIG. 2.

FIG. 10 is an enlarged cross-sectional view along line X-X in FIG. 9.

FIG. 11 is an enlarged cross-sectional view showing a state in which the stay is inserted into the headrest skin material in the process indicated in S5 of the flowchart in FIG. 2.

FIG. 12 is a bottom view showing a state in which, after the stay is inserted into the headrest skin material, the second tongue piece is folded inward of the headrest skin material according to Embodiment 1.

FIG. 13 is an enlarged cross-sectional view along line XIII-XIII in FIG. 12.

FIG. 14 is a bottom view showing a state in which, after the stay is inserted into the headrest skin material, the first tongue piece is folded inward of the headrest skin material according to Embodiment 1.

FIG. 15 is an enlarged cross-sectional view along line XV-XV in FIG. 14.

FIG. 16 is an enlarged cross-sectional view showing a process for injecting foamed resin into the inside of the headrest skin material according to Embodiment 1.

FIG. 17 is a plan view showing a state in which a first skin piece and a seal skin piece are sewn together according to Embodiment 2.

FIG. 18 is a flowchart showing a manufacturing process of a headrest according to Embodiment 3.

FIG. 19 is a bottom view showing a headrest skin material according to Embodiment 3.

FIG. 20 is an enlarged cross-sectional view along line XX-XX in FIG. 19.

FIG. 21 is an enlarged cross-sectional view along line XXI-XXI in FIG. 19.

FIG. 22 is an enlarged cross-sectional view of a headrest skin material according to Embodiment 4, which corresponds to a cross-section along line VII-VII in FIG. 6.

FIG. 23 is an enlarged cross-sectional view of a headrest skin material according to Embodiment 5, which corresponds to a cross-section along line VII-VII in FIG. 6.

FIG. 24A to FIG. 24C are plan views showing a first skin piece, a second skin piece, and a seal skin piece according to Embodiment 6.

FIG. 25 is a bottom view showing a state in which a first tongue piece of the first skin piece is pulled outward in a headrest skin material according to Embodiment 6.

FIG. 26 is an enlarged cross-sectional view showing a state in which a stay is inserted into the headrest skin material according to Embodiment 6.

FIG. 27 is an enlarged cross-sectional view showing a state in which, after the stay is inserted into the headrest skin material, the first tongue piece is folded inward of the headrest skin material according to Embodiment 6.

FIG. 28A to FIG. 28B are plan views showing a seal skin piece according to another embodiment (2). FIG. 28A shows a configuration in which, in a short direction of the seal skin piece, a second slit connects one ends of hole edges of a pair of second insertion holes. FIG. 28B shows a configuration in which, in the short direction of the seal skin piece, the second slit connects the other ends of the hole edges of the pair of second insertion holes.

### DESCRIPTION OF THE EMBODIMENTS

The disclosure provides a headrest skin material and a headrest in which a stay to which a structure is attached is arranged inside the skin material and the leakage of foamed resin can be suppressed.

According to one aspect of the disclosure, between a stay opening and the injection port, a double configuration is achieved with the seal skin piece located inside and the first skin piece located outside. Furthermore, on a side opposite to the injection port from the stay opening, a double configuration is also achieved with the seal skin piece located inside and the first skin piece located outside. In this way, a double configuration including the seal skin piece and the first skin piece is achieved both on the injection port side and on the side opposite to the injection port with the stay opening as the center.

In detail, the pair of first slits formed in the first skin piece are covered by the seal skin piece from the inside of the first skin piece. Thus, the foamed resin is prevented from reaching the pair of first slits. As a result, the leakage of foamed resin from the pair of first slits can be suppressed.

The second slit formed in the seal skin piece is covered from the outside by the first skin piece. Thus, even if the foamed resin reaches the second slit, since the first skin piece is present outside the second slit, the leakage of foamed resin to the outside via the second slit can be suppressed.

Since the injection port is covered by the first tongue piece, the leakage of foamed resin from the injection port can be suppressed.

According to another aspect of the disclosure, the stay on which the structure is arranged can be arranged inside the headrest. Since the pair of first slits are covered by the seal skin piece from the inside of the first skin piece, the foamed resin is prevented from reaching the pair of first slits. As a result, the leakage of foamed resin from the pair of first slits can be suppressed. Since the first skin piece is present outside the second slit, the leakage of foamed resin to the outside via the second slit can be suppressed. Furthermore, since the injection port is covered by the first tongue piece, the leakage of foamed resin from the injection port can be suppressed.

The reference numerals in parentheses in the claims indicate the correspondence with specific means described in the embodiments described later, and do not limit the technical scope of the disclosure.

### Embodiment 1

Embodiment 1 related to a headrest skin material and a headrest using a headrest skin material according to the disclosure will be described below. The headrest according to the present embodiment is, for example, attached to an upper part of a seat (not shown) arranged in a vehicle interior of a vehicle (not shown).

### 1. Overall Configuration

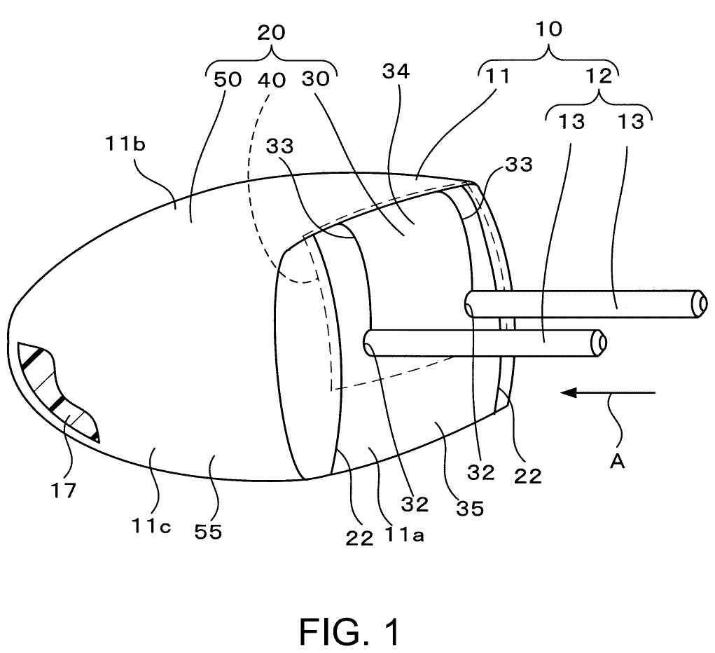

As shown in FIG. 1, a headrest 10 includes a pad 11, and a stay 12 that is arranged inside the pad 11 and protrudes from a bottom 11a of the pad 11.

### 2. Stay 12

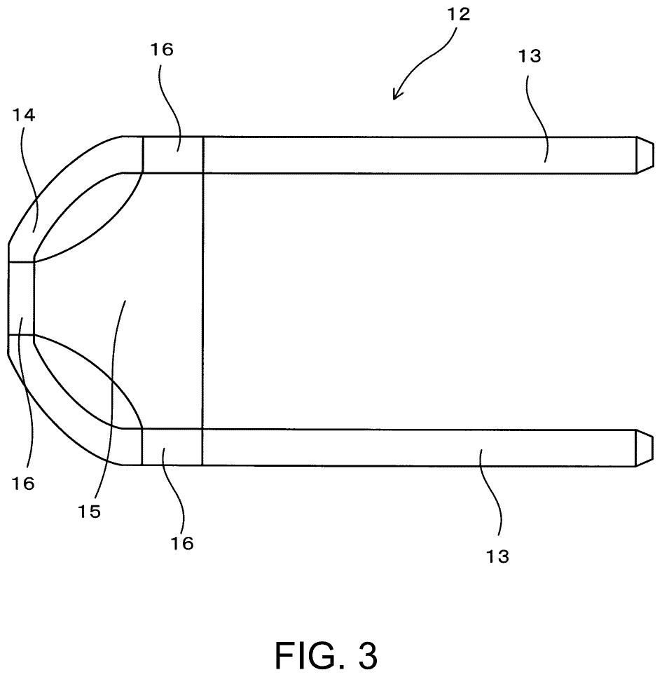

As shown in FIG. 3, the stay 12 is formed by bending and machining a rod made of metal into a substantial U-shape. The stay 12 includes a pair of legs 13, and a connecting part 14 that connects one ends of the pair of legs 13. In the vicinity of the connecting part 14 of the stay 12, a structure 15 is attached that is connected to the pair of legs 13 and also connected to the connecting part 14. The structure 15 may be, for example, a reinforcing member for protecting a seated person's head. The structure 15 is composed of a metal plate material, and includes a protrusion 16 that protrudes in three directions in which connection to the pair of legs 13 and the connecting part 14 is possible. The protrusions 16 are fixed to the pair of legs 13 and the connecting part 14 respectively by a known method such as crimping, welding, or brazing and soldering. The stay 12 may be reinforced by the structure 15. However, the structure 15 may be any member selected from, in addition to a reinforcing member, an electrical part such as a heater and a speaker.

### 3. Pad 11

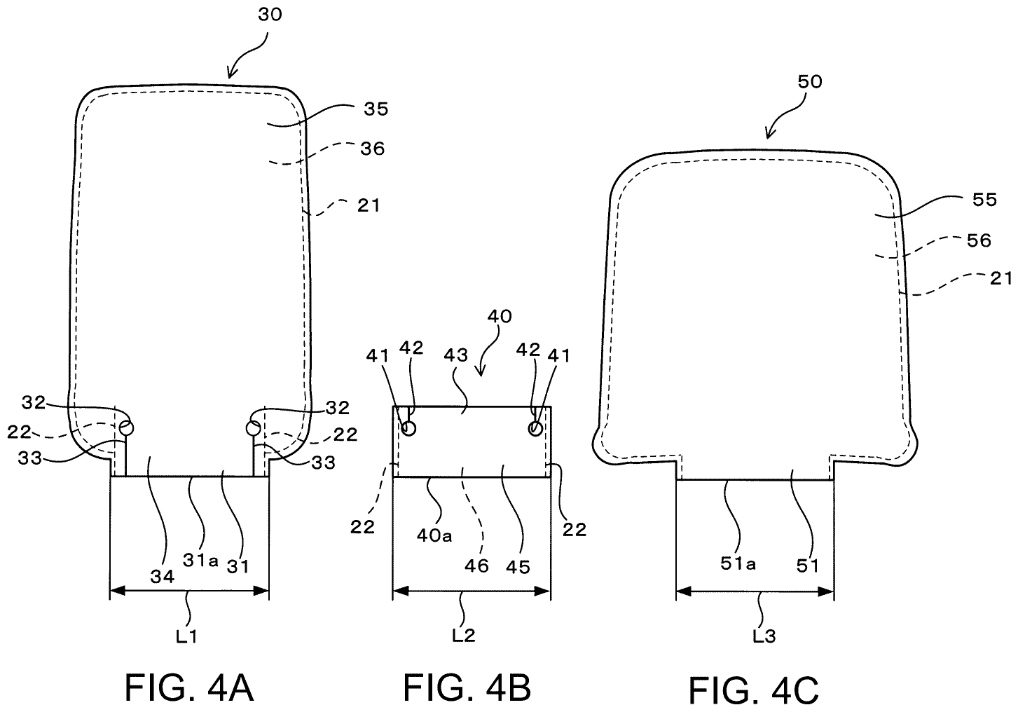

The pad 11 will be described with reference to FIG. 1 and FIG. 4A to FIG. 4C. As shown in FIG. 1, the pad 11 is configured by filling foamed resin 17 inside a headrest skin material 20 formed in a bag shape. The pad 11 is formed in a pillow-like shape.

The pad 11 includes: the bottom 11a, from which the stay 12 protrudes; a front surface part 11b, extending in a direction intersecting the bottom 11a from a side edge of the bottom 11a and contacting the seated person's head; a back surface part (not shown), facing away from the front surface part 11b; and a side surface part 11c, intersecting the front surface part 11b and the back surface part.

A surface of the pad 11 is formed by the headrest skin material 20. The headrest skin material 20 is formed by sewing multiple (in the present embodiment, three) skin pieces 30, 40, and 50. As shown in FIG. 4A to FIG. 4C, the multiple skin pieces 30, 40, and 50 include a first skin piece 30, a seal skin piece 40, and a second skin piece 50. However, the number of skin pieces is not limited, and may be four or more.

The first skin piece 30, the seal skin piece 40, and the second skin piece 50 are, for example, fabric skins, skins obtained by sewing two-layer skin pieces composed of polyurethane or polyvinyl chloride resin films, or cut pile fabric using a synthetic fiber such as acrylic or polyester as pile yarn and cotton or rayon as ground warp.

The first skin piece 30 and the second skin piece 50 include design surfaces 35 and 55 arranged on an outside of the completed pad 11, and inner surfaces 36 and 56 arranged on an inside of the pad 11. The first skin piece 30 and the second skin piece 50 are made of the same fabric. A fabric constituting the seal skin piece 40 is not particularly limited, and the same fabric as that for the first skin piece 30 and the second skin piece 50 or a different fabric may be used. In the present embodiment, the same fabric as that for the first skin piece 30 and the second skin piece 50 is used for the seal skin piece 40. Hence, the seal skin piece 40 also includes a design surface 45 and an inner surface 46. The seal skin piece 40 is arranged so that a portion visible from a first slit 33 described later serves as the design surface 45. Accordingly, the appearance of the headrest 10 is improved.

As shown in FIG. 4A to FIG. 4C, the headrest skin material 20 constituting the pad 11 is formed by sewing together a side edge of the first skin piece 30 and a side edge of the second skin piece 50 along a first seam 21 at a position slightly inside the side edges in a state in which the side edges are overlapped. Accordingly, the first skin piece 30 and the second skin piece 50 are arranged adjacent to each other.

### 4. First Skin Piece 30

As shown in FIG. 4A, the first skin piece 30 is of a rounded square shape as a whole. In the first skin piece 30, a peripheral edge of a portion constituting the bottom 11a has a first projecting piece 31 formed protruding from the peripheral edge. The first projecting piece 31 is formed in a rectangular shape.

As shown in FIG. 4A, in the first skin piece 30, a pair of first insertion holes 32 penetrate at a position slightly inward of the first projecting piece 31 and are aligned substantially parallel to a tip edge of the first projecting piece 31. The first insertion hole 32 has an inner shape that is circular. The first insertion hole 32 is formed to have an inner diameter dimension equal to or slightly smaller than an outer dimension of the leg 13 of the stay 12. A spacing between the pair of first insertion holes 32 is formed to be substantially equal to a spacing between the pair of legs 13. Each of the pair of first insertion holes 32 allows insertion of each of the pair of legs 13 therethrough.

In the first skin piece 30, a pair of first slits 33 are formed extending from hole edges of the pair of first insertion holes 32 to the tip edge of the first projecting piece 31. In the first skin piece 30, an area formed between the pair of first slits 33 is taken as a first tongue piece 34. The first tongue piece 34 is formed to be freely bendable and deformable.

### 5. Seal Skin Piece 40

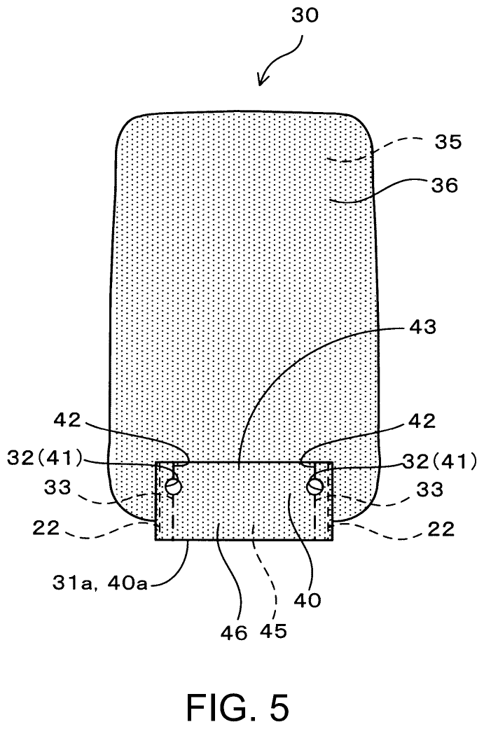

The seal skin piece 40 will be described with reference to FIG. 4B and FIG. 5. As shown in FIG. 5, one side edge 40a of the seal skin piece 40 is arranged to coincide with a tip edge 31a of the first projecting piece 31 formed in the first skin piece 30. The seal skin piece 40 is arranged such that the inner surface 36 of the first skin piece 30 and the design surface 45 of the seal skin piece 40 face each other.

The seal skin piece 40 is formed in a rectangular shape with the side edge arranged to coincide with the tip edge 31a of the first projecting piece 31 being the long side. As shown in FIG. 4B, among the side edges of the seal skin piece 40, a length dimension L2 of the side edge 40a coinciding with the tip edge 31a of the first projecting piece 31 is set to be substantially equal to a length dimension L1 of the tip edge 31a of the first projecting piece 31.

As shown in FIG. 5, the seal skin piece 40 is arranged to cover an area wider than an area where the pair of first slits 33 and the pair of first insertion holes 32 are formed in the first skin piece 30. The seal skin piece 40 is sewn to the first skin piece 30 at a position outside the pair of first slits 33 in a direction in which the pair of first slits 33 are aligned. A second seam 22 is formed at positions where both the seal skin piece 40 and the first skin piece 30 are sewn together.

In the seal skin piece 40, a pair of second insertion holes 41 are formed at positions overlapping the pair of first insertion holes 32 in a state in which the seal skin piece 40 is attached to the first skin piece 30. The second insertion hole 41 has an inner shape that is circular. The second insertion hole 41 is formed to have an inner diameter dimension equal to or slightly smaller than the outer dimension of the leg 13. Each of the pair of second insertion holes 41 allows insertion of each of the pair of legs 13 therethrough.

In the seal skin piece 40, a pair of second slits 42 are formed extending from hole edges of the pair of second insertion holes 41 to an edge opposite to the side edge that coincides with the tip edge 31a of the first projecting piece 31. Each of the pair of second slits 42 is formed to have a width smaller than a span dimension of each of the pair of second insertion holes 41. In the seal skin piece 40, an area formed between the hole edges of the pair of second insertion holes 41 and the pair of second slits 42 is taken as a second tongue piece 43. The second tongue piece 43 is formed to be freely bendable and deformable.

As shown in FIG. 5, in the state in which the seal skin piece 40 is attached to the first skin piece 30, the first slit 33 of the first skin piece 30 and the second slit 42 of the seal skin piece 40 are formed in shapes extending in substantially the same direction. Accordingly, a configuration is achieved in which the second slit 42 is arranged on an extension line of the first slit 33.

### 6. Second Skin Piece 50

As shown in FIG. 4C, the second skin piece 50 is of a rounded square shape as a whole. In the second skin piece 50, a peripheral edge constituting a side edge of the bottom 11a of the pad 11 has a second projecting piece 51 formed protruding from the peripheral edge. The second projecting piece 51 is formed in a substantially rectangular shape. The second projecting piece 51 of the second skin piece 50 and the first projecting piece 31 of the first skin piece 30 are formed in substantially the same shape. That is, a protrusion dimension of the first projecting piece 31 from the peripheral edge of the first skin piece 30 and a protrusion dimension of the second projecting piece 51 from the peripheral edge of the second skin piece 50 are substantially equal. In a direction intersecting a protrusion direction, the length dimension L1 of the tip edge 31a of the first projecting piece 31 and a length dimension L3 of a tip edge 51a of the second projecting piece 51 are substantially equal.

### 7. Example of Manufacturing Process of Embodiment

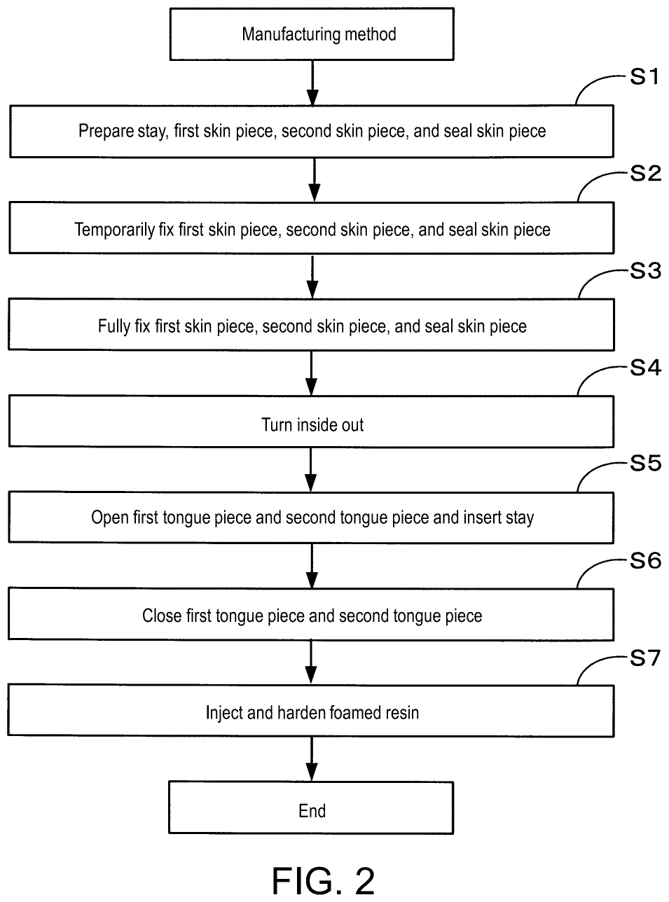

Subsequently, an example of a manufacturing process of the headrest skin material 20 and the headrest 10 according to the present embodiment will be described with reference to FIG. 1 to FIG. 16. FIG. 2 shows a flowchart of a manufacturing method of the headrest 10 and the headrest skin material 20 according to the present embodiment. The manufacturing process is not limited to the following description.

As shown in FIG. 2 and FIG. 3, the stay 12 is formed into a predetermined shape (S1). As shown in FIG. 2 and FIG. 4A to FIG. 4C, the first skin piece 30, the second skin piece 50, and the seal skin piece 40 are cut into a predetermined shape (S1). As shown in FIG. 2 and FIG. 5, the seal skin piece 40 is placed on the inner surface 36 of the first skin piece 30 so that the inner surface 36 of the first skin piece 30 and the design surface 45 of the seal skin piece 40 face each other. At this time, the pair of first insertion holes 32 of the first skin piece 30 and the second insertion hole 41 of the seal skin piece 40 are arranged so that their positions substantially align, and the tip edge 31a of the first projecting piece 31 of the first skin piece 30 and the side edge 40a of the seal skin piece 40 are arranged to coincide.

As shown in FIG. 2 and FIG. 5, the seal skin piece 40 and the first skin piece 30 are sewn together at a position outside the pair of first slits 33 in the direction in which the pair of first slits 33 are aligned. Accordingly, the seal skin piece 40 and the first skin piece 30 are temporarily fixed. The seal skin piece 40 is sewn from a portion overlapping the tip edge 31a of the first projecting piece 31 to an edge facing away from the tip edge 31a of the first projecting piece 31. Accordingly, the second seam 22 where the seal skin piece 40 and the first skin piece 30 are sewn together is formed from the portion of the seal skin piece 40 overlapping the tip edge 31a of the first projecting piece 31 to the edge facing away from the tip edge 31a of the first projecting piece 31. However, the process for temporarily fixing the seal skin piece 40 and the first skin piece 30 may be omitted.

The first skin piece 30 and the second skin piece 50 are overlapped with the design surface 35 of the first skin piece 30 and the design surface 55 of the second skin piece 50 facing each other. A side edge of the first skin piece 30 and a side edge of the second skin piece 50 are sewn together (S3 in FIG. 2). At this time, no sewing is performed in an area except for the tip edge 31a of the first projecting piece 31 of the first skin piece 30, the tip edge 51a of the second projecting piece 51 of the second skin piece 50, and both side edges of the side edge 40a of the seal skin piece 40 arranged to coincide with the tip edge 31a of the first projecting piece 31. In a portion where a side edge of the first projecting piece 31 and a side edge of the second projecting piece 51 are sewn together, a portion of a sewn portion between the first projecting piece 31 of the first skin piece 30 and the seal skin piece 40 serves as a sewn portion between the first skin piece 30 and the second skin piece 50.

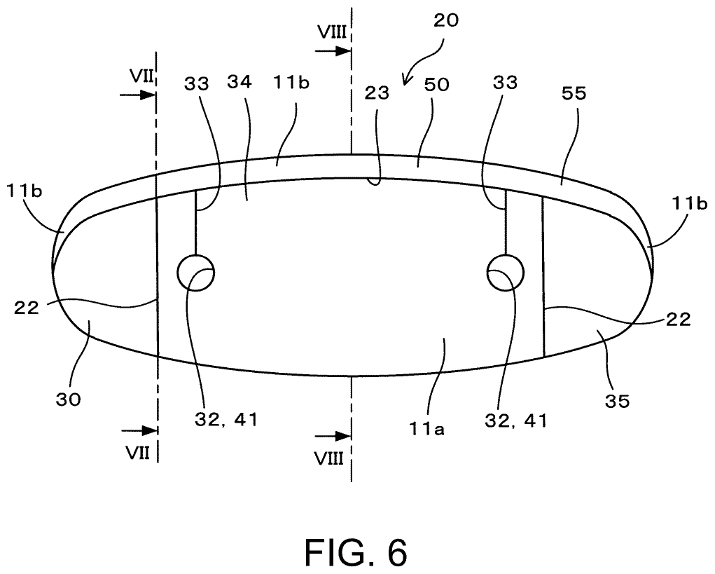

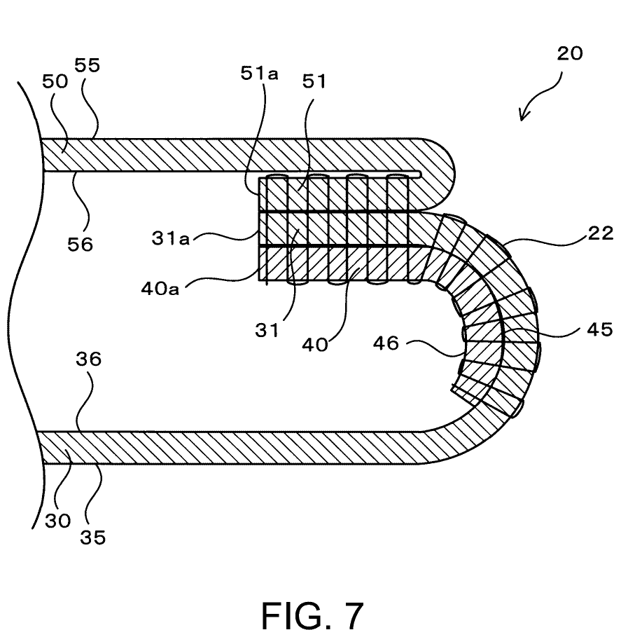

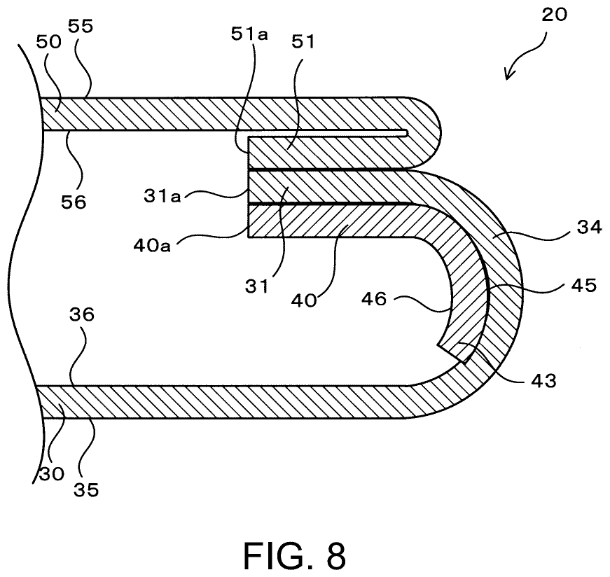

As shown in FIG. 2, after the first skin piece 30, the second skin piece 50, and the seal skin piece 40 are sewn together, the first skin piece 30, the second skin piece 50, and the seal skin piece 40 are turned inside out so that the design surfaces 35 and 55 of the first skin piece 30 and the second skin piece 50 face outward (S4). Accordingly, the headrest skin material 20 is completed (see FIG. 6). FIG. 6 is a view of the headrest skin material 20 as seen from arrow line A shown in FIG. 1. In this state, as shown in FIG. 7 and FIG. 8, the first projecting piece 31 and the second projecting piece 51 are arranged to face each other and protrude inward of the headrest skin material 20. Furthermore, the side edge 40a of the seal skin piece 40 sewn to the first projecting piece 31 also protrudes inward of the headrest skin material 20. An unsewn portion of the tip edge 31a of the first projecting piece 31, the tip edge 51a of the second projecting piece 51, and the side edge 40a of the seal skin piece 40 is taken as an injection port 23 into which a nozzle 18 for injecting the foamed resin 17 into the inside of the headrest skin material 20 is inserted. In other words, the tip edge 31a of the first projecting piece 31 and the tip edge 51a of the second projecting piece 51 are configured to be sewn together except for the injection port 23.

As shown in FIG. 7 and FIG. 8, the seal skin piece 40 is arranged inside the first skin piece 30. Accordingly, the pair of first slits 33 of the first skin piece 30 are covered by the seal skin piece 40 from the inside of the headrest skin material 20.

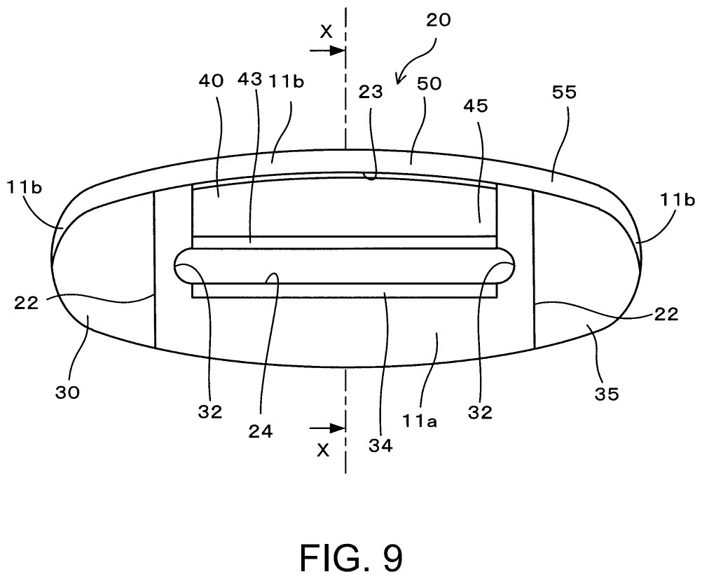

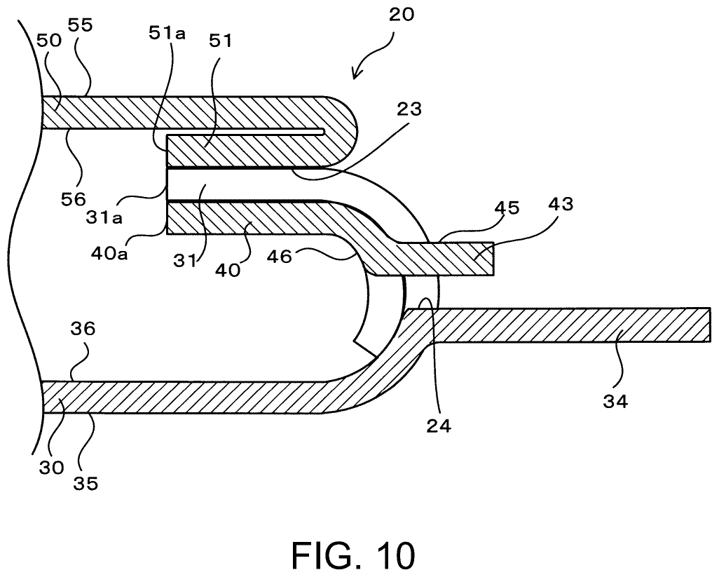

As shown in FIG. 2, FIG. 9, and FIG. 10, the first tongue piece 34 of the first skin piece 30 is pulled outward of the headrest skin material 20 while being bent and deformed. The second tongue piece 43 of the seal skin piece 40 is pulled outward of the headrest skin material 20 while being bent and deformed (S5). However, the second tongue piece 43 may also be pushed inward into the headrest skin material 20.

As shown in FIG. 2, FIG. 9, and FIG. 10, by pulling out the first tongue piece 34 and the second tongue piece 43, a gap is formed between the first tongue piece 34 and the second tongue piece 43. This gap serves as a stay opening 24 for inserting the stay 12 into the inside of the headrest skin material 20. As shown in FIG. 9, the stay opening 24 is formed in a slit-like shape connecting the pair of first insertion holes 32 to each other and the pair of second insertion holes 41 to each other. The stay opening 24 is formed to have an inner shape the same as or slightly larger than an outer shape of the stay 12.

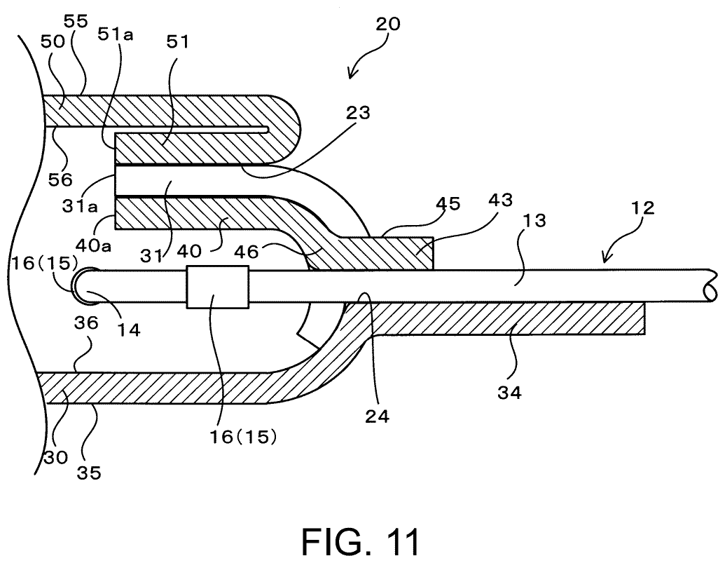

As shown in FIG. 2 and FIG. 11, regarding an insertion direction of the stay 12 into the headrest skin material 20, the stay 12 is inserted into the inside of the headrest skin material 20 from the stay opening 24 with the connecting part 14 of the stay 12 on the front side (S5).

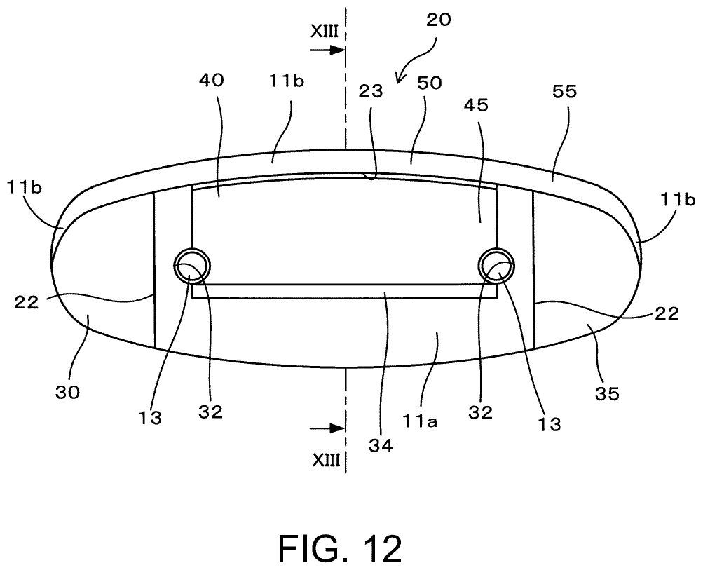

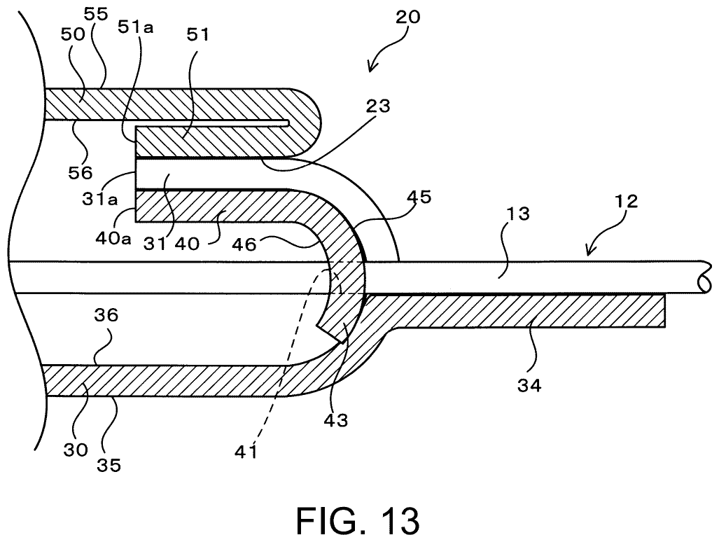

As shown in FIG. 2, FIG. 12, and FIG. 13, after the stay 12 is inserted to a predetermined insertion depth, the second tongue piece 43 is inserted into the inside of the headrest skin material 20. Accordingly, the stay opening 24 is closed by the second tongue piece 43 (S6). As shown in FIG. 13, in this state, the leg 13 of the stay 12 is in a state of being inserted through the second insertion hole 41.

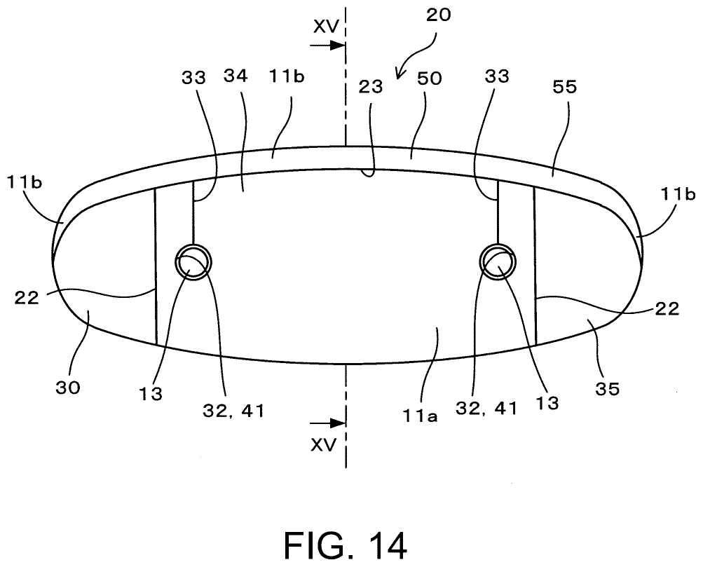

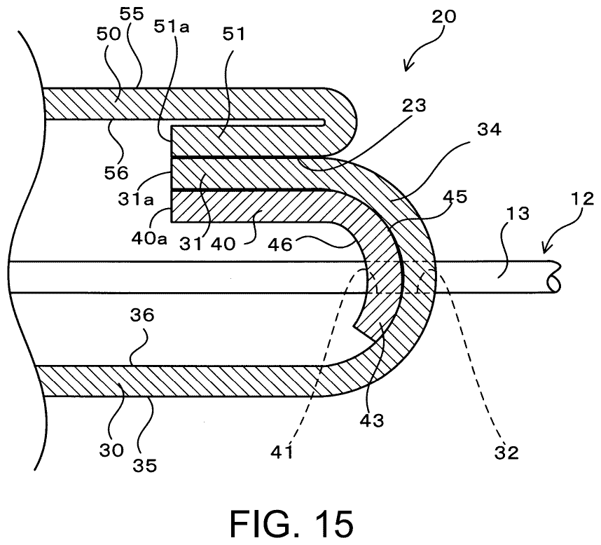

Subsequently, as shown in FIG. 2, FIG. 14, and FIG. 15, the first tongue piece 34 is bent and deformed as a whole, and the first projecting piece 31 is inserted into a gap between the second projecting piece 51 and the seal skin piece 40 to cover the seal skin piece 40. As shown in FIG. 14, in this state, the leg 13 of the stay 12 is in a state of being inserted through the first insertion hole 32 (S6). Accordingly, the stay opening 24 is configured to be doubly covered by the second tongue piece 43 and the first tongue piece 34. Between the stay opening 24 and the injection port 23, a double configuration is achieved with the seal skin piece 40 located inside and the first skin piece 30 located outside. Furthermore, on a side opposite to the injection port 23 from the stay opening 24, a double configuration is also achieved with the seal skin piece 40 located inside and the first skin piece 30 located outside. In this way, a double configuration including the seal skin piece 40 and the first skin piece 30 is achieved both on the injection port 23 side and on the side opposite to the injection port 23 with the stay opening 24 as the center.

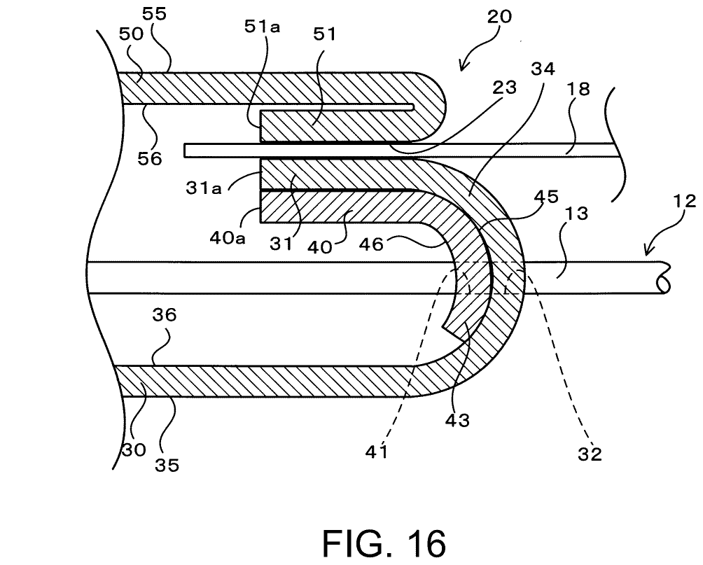

As shown in FIG. 2 and FIG. 16, a tip of the nozzle 18 is inserted into the injection port 23. A predetermined amount of the foamed resin 17 in the liquid form is injected from the nozzle 18 into the inside of the headrest skin material 20. Before the foamed resin 17 hardens, the nozzle 18 is removed from the injection port 23. After that, the foamed resin 17 is allowed to foam and harden (S7). At this time, since the pair of first slits 33 of the first skin piece 30 are covered by the seal skin piece 40 from the inside of the headrest skin material 20, the foamed resin 17 is prevented from reaching the pair of first slits 33. Accordingly, the leakage of foamed resin 17 from the pair of first slits 33 is suppressed.

Since the injection port 23 into which the foamed resin 17 is injected is covered by the first projecting piece 31, the second projecting piece 51, and the seal skin piece 40, the foamed resin 17 is prevented from leaking from the injection port 23. In detail, the first projecting piece 31, the second projecting piece 51, and the seal skin piece 40 are self-sealed with the hardened foamed resin 17, thereby suppressing the leakage of foamed resin 17 from the injection port 23. As shown in FIG. 1, according to the above, the headrest 10 is completed.

### 8. Effects of Embodiment

Subsequently, effects of the present embodiment will be described. According to the present embodiment, the pair of first slits 33 formed in the first skin piece 30 are covered by the seal skin piece 40 from the inside of the first skin piece 30. Thus, the foamed resin 17 is prevented from reaching the pair of first slits 33. As a result, the leakage of foamed resin 17 from the pair of first slits 33 can be suppressed.

The pair of second slits 42 formed in the seal skin piece 40 are covered from the outside by the first skin piece 30. Thus, even if the foamed resin 17 reaches the pair of second slits 42, since the first skin piece 30 is present outside the pair of second slits 42, the leakage of foamed resin 17 to the outside via the pair of second slits 42 can be suppressed.

Since the injection port 23 is covered by the first tongue piece 34, the leakage of foamed resin 17 from the injection port 23 can be suppressed.

According to the present embodiment, one side edge of the seal skin piece 40 is formed to have a length dimension equal to a width dimension of the first projecting piece 31 in a direction intersecting a protrusion direction of the first projecting piece 31. One side edge of the seal skin piece 40 is arranged to coincide with the tip edge 31a of the first projecting piece 31. By arranging the tip edge 31a of the first projecting piece 31 to coincide with one side edge of the seal skin piece 40, the first projecting piece 31 and the seal skin piece 40 can be easily aligned.

According to the present embodiment, the seal skin piece 40 is engaged with the inner surface 36 of the first skin piece 30 from the portion overlapping the tip edge 31a of the first projecting piece 31 to the edge facing away from the tip edge 31a of the first projecting piece 31 at the position outside the pair of first slits 33 in the direction in which the pair of first slits 33 are aligned on the inner surface 36 of the first skin piece 30. Accordingly, when the foamed resin 17 is injected into the inside of the headrest skin material 20, positional deviation of an area from the portion of the seal skin piece 40 overlapping the tip edge 31a of the first projecting piece 31 to the edge facing away from the tip edge 31a of the first projecting piece 31 due to a pressure of the foamed resin 17 that flows is suppressed. As a result, the leakage of foamed resin 17 from the pair of first slits 33 and the pair of second slits 42 can be suppressed.

According to the present embodiment, the first skin piece 30 and the seal skin piece 40 are engaged by being sewn together. According to the present embodiment, in a process for sewing the first skin piece 30, the second skin piece 50, and the seal skin piece 40 that constitute the headrest skin material 20, the first skin piece 30 and the seal skin piece 40 can be sewn together, thereby improving the efficiency of manufacturing the headrest skin material 20. Since positional deviation of the first skin piece 30 and the seal skin piece 40 can be suppressed, the leakage of foamed resin 17 from the pair of first slits 33 can further be suppressed.

According to the present embodiment, a portion of the sewn portion between the first skin piece 30 and the seal skin piece 40 serves as the sewn portion between the first skin piece 30 and the second skin piece 50.

Since at least the first skin piece 30, the seal skin piece 40, and the second skin piece 50 are sewn together at the same portion, positional deviation of the first skin piece 30, the seal skin piece 40, and the second skin piece 50 due to the pressure of the foamed resin 17 that flows can be suppressed. Accordingly, the leakage of foamed resin 17 from the pair of first slits 33 can further be suppressed.

According to the present embodiment, the seal skin piece 40 is formed in a rectangular shape with the side edge arranged to coincide with the tip edge 31a of the first projecting piece 31 being configured as one of a pair of long sides.

The seal skin piece 40 formed in a rectangular shape can cover from the inside the pair of first slits 33 of the first skin piece 30 over the entire length thereof. Accordingly, the leakage of foamed resin 17 from the pair of first slits 33 can further be suppressed.

Since the tip edge 31a of the first projecting piece 31, the tip edge 51a of the second projecting piece 51, and the side edge 40a of the seal skin piece 40 are arranged to coincide, it is prevented that the tip edge 31a of the first projecting piece 31, the tip edge 51a of the second projecting piece 51, or the side edge 40a of the seal skin piece 40 is turned up due to receiving the pressure of the foamed resin 17 that flows. Accordingly, the leakage of foamed resin 17 from the injection port 23 is further suppressed.

The headrest 10 according to the present embodiment includes: the headrest skin material 20; the stay 12, on which the structure 15 is arranged at a portion arranged inside the headrest skin material 20, and through which the leg 13 is inserted from the pair of first insertion holes 32 and the pair of second insertion holes 41; and the foamed resin 17, filled inside the headrest skin material 20. According to the present embodiment, the stay 12 on which the structure 15 is arranged can be arranged inside the headrest skin material 20. Since the pair of first slits 33 are covered by the seal skin piece 40 from the inside of the first skin piece 30, the foamed resin 17 is prevented from reaching the pair of first slits 33. As a result, the leakage of foamed resin 17 from the pair of first slits 33 can be suppressed. Since the first skin piece 30 is present outside the pair of second slits 42, the leakage of foamed resin 17 to the outside via the pair of second slits 42 can be suppressed. Furthermore, since the injection port 23 is covered by the first tongue piece 34, the leakage of foamed resin 17 from the injection port 23 can be suppressed.

### Embodiment 2

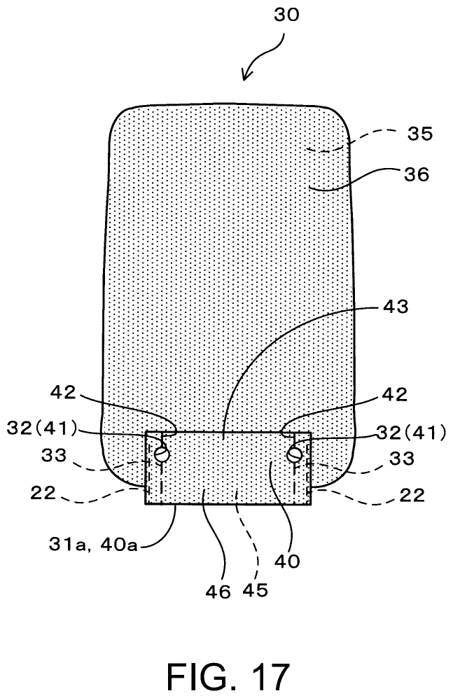

Next, Embodiment 2 will be described with reference to FIG. 17. In the present embodiment, the seal skin piece 40 is sewn to the inner surface 36 of the first skin piece 30 at least from the portion overlapping the tip edge 31a of the first projecting piece 31 to a portion overlapping an area where the pair of first insertion holes 32 are formed at a position outside the pair of first slits 33 in the direction in which the pair of first slits 33 are aligned on the inner surface 36 of the first skin piece 30.

In Embodiment 2 and subsequent embodiments, among the reference numerals used, those that are identical to the reference numerals used in the previous embodiments represent similar components or the like as in the previous embodiments, unless otherwise specified.

According to the present embodiment, when the foamed resin 17 is injected into the inside of the headrest skin material 20, positional deviation of the portion of the seal skin piece 40 overlapping the tip edge 31a of the first projecting piece 31 through the portion overlapping the area where the pair of first insertion holes 32 due to the pressure of the foamed resin 17 that flows is suppressed. Accordingly, positional deviation of the seal skin piece 40 from the pair of first slits 33 of the first skin piece 30 is suppressed. As a result, the leakage of foamed resin 17 from the pair of first slits 33 can be suppressed.

### Embodiment 3

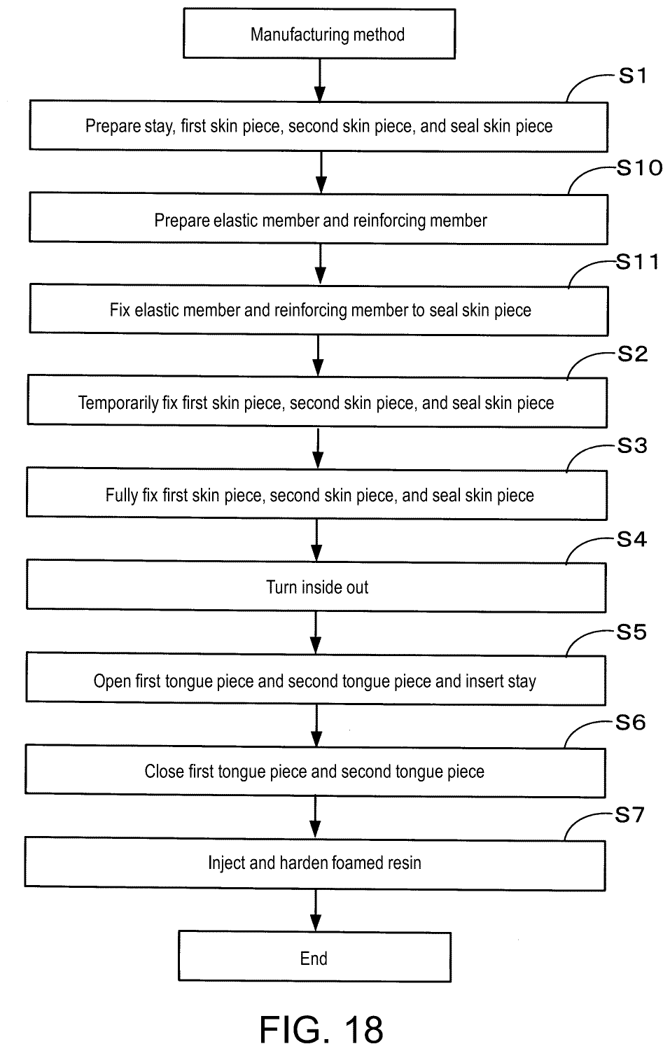

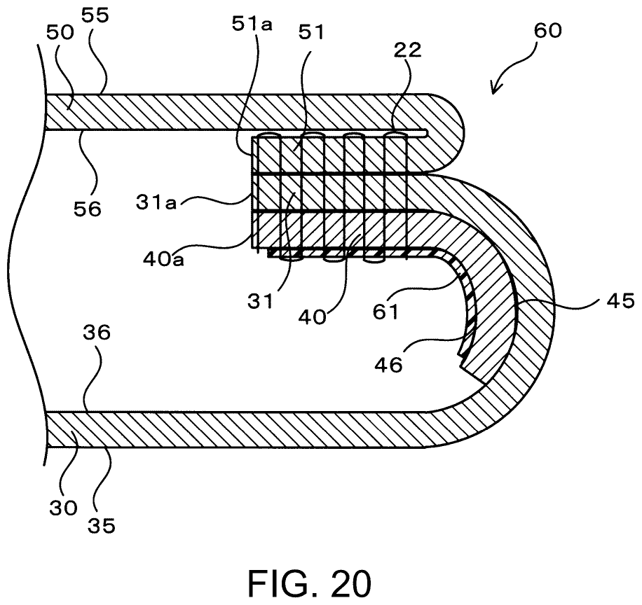

Next, a headrest skin material 60 according to Embodiment 3 will be described with reference to FIG. 18 to FIG. 21. As shown in FIG. 20, the seal skin piece 40 according to the present embodiment is sewn to a portion of the inner surface 36 of the first skin piece 30 where the first projecting piece 31 and the seal skin piece 40 overlap at a position outside the pair of first slits 33 in the direction in which the pair of first slits 33 are aligned on the inner surface 36 of the first skin piece 30.

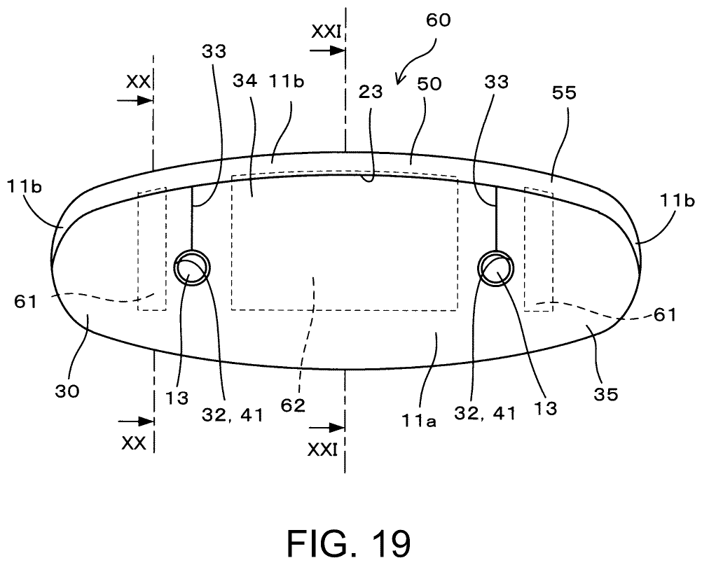

The portion where the first skin piece 30 and the seal skin piece 40 are sewn together protrudes inward of the headrest skin material 60, and is thus not exposed to the outside of the headrest skin material 60. Hence, as shown in FIG. 19, the second seam 22 for sewing the first skin piece 30 and the seal skin piece 40 together is not exposed on the bottom 11a of the headrest skin material 60.

As shown in FIG. 19, on a back surface of the seal skin piece 40, an elastically deformable elastic member 61 is fixed at a position outside the pair of first slits 33 in the direction in which the pair of first slits 33 are aligned. The elastic member 61 is formed in a plate shape. In the present embodiment, the elastic member 61 is formed in an elongated rectangular shape. However, the shape of the elastic member 61 is not limited to a rectangular shape, and may be any shape such as an elongated oval shape. The elastic member 61 is configured to be capable of applying an elastic force in a plate thickness direction by bending and deformation.

The seal skin piece 40 and the elastic member 61 are fixed using a known method such as an adhesive. In the present embodiment, portions of the elastic member 61 overlapping the first projecting piece 31 of the first skin piece 30, the second projecting piece 51 of the second skin piece 50, and the seal skin piece 40 are sewn together (see FIG. 20). However, the elastic member 61 may be configured to be arranged at a position not overlapping the first projecting piece 31 and the second projecting piece 51. In this case, the first projecting piece 31 of the first skin piece 30, the second projecting piece 51 of the second skin piece 50, and the seal skin piece 40 are configured to be sewn together.

The elastic member 61 is made of an elastically deformable resin. The resin constituting the elastic member 61 may be appropriately selected from any resin such as polyolefin, polyamide, and polyester.

As shown in FIG. 20, the elastic member 61 is bent and deformed following the shape of the seal skin piece 40. Accordingly, the elastic member 61 applies an elastic force to the seal skin piece 40. Accordingly, the seal skin piece 40 is pressed against a back surface of the first skin piece 30. As a result, the seal skin piece 40 is engaged in contact with the back surface of the first skin piece 30. In this way, according to the present embodiment, since the seal skin piece 40 and the first skin piece 30 can be engaged without being sewn together, the second seam 22 is not exposed on an outer surface of the first skin piece 30. As a result, the appearance of the headrest skin material 60 can be improved.

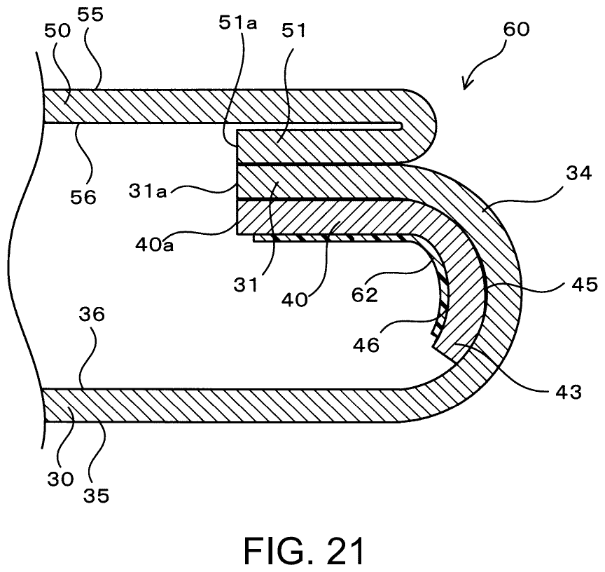

As shown in FIG. 19 and FIG. 21, on the back surface of the seal skin piece 40, in an area that is between the pair of first slits 33 of the first skin piece 30 and slightly smaller than the first tongue piece 34 of the first skin piece 30, an elastically deformable reinforcing member 62 is fixed. In the present embodiment, the reinforcing member 62 is formed in a rectangular plate shape. The reinforcing member 62 is configured to be capable of applying an elastic force in the plate thickness direction by bending and deformation. However, the reinforcing member 62 may be formed in any shape.

The seal skin piece 40 and the reinforcing member 62 are fixed using a known method such as an adhesive or a pressure sensitive adhesive. The reinforcing member 62 is made of an elastically deformable resin. The resin constituting the reinforcing member 62 may be the same as or different from the resin constituting the elastic member 61.

FIG. 18 is a flowchart showing a manufacturing method of the headrest 10 and the headrest skin material 60 according to the present embodiment. As shown in FIG. 18, in the present embodiment, an elastic member and a reinforcing member are formed into a predetermined shape (S10). After that, the elastic member 61 and the reinforcing member 62 are adhered to the inner surface 36 of the seal skin piece 40 (S11). For the processes other than those mentioned above, the same processes as those in the manufacturing method of the headrest 10 and the headrest skin material 20 of Embodiment 1 shown in FIG. 2 described above are assigned the same reference numerals, and the repeated descriptions are omitted.

Since the seal skin piece 40 is reinforced by the reinforcing member 62, when the foamed resin 17 is injected inside the headrest skin material 60, bending and deformation of the seal skin piece 40 due to the pressure of the foamed resin 17 that flows are suppressed. Accordingly, positional deviation of the seal skin piece 40 from the pair of first slits 33 can be suppressed. Thus, the leakage of foamed resin 17 from the pair of first slits 33 can further be suppressed.

By the elastic force of the reinforcing member 62, the seal skin piece 40 is pressed against the inner surface 36 of the first skin piece 30, thereby improving adhesion between the seal skin piece 40 and the first skin piece 30. Accordingly, the foamed resin 17 can further be prevented from reaching the pair of first slits 33. Furthermore, since the pair of second slits 42 are covered by the first skin piece 30 that adheres closely to the seal skin piece 40, the leakage of foamed resin 17 from the pair of second slits 42 can also further be suppressed.

### Embodiment 4

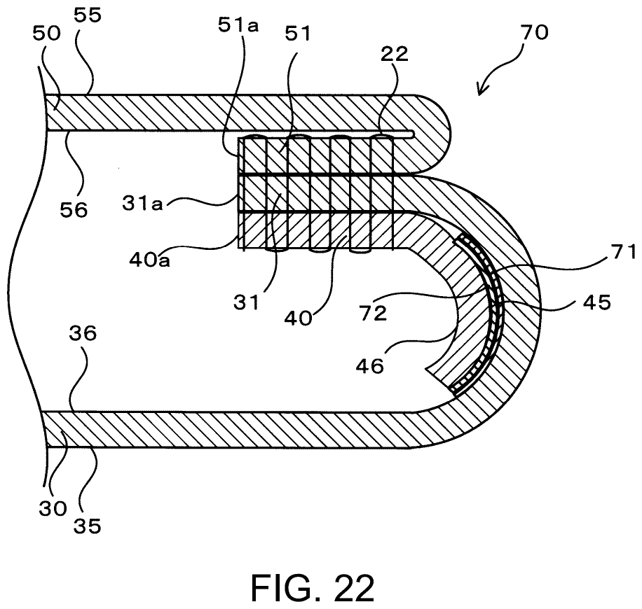

Next, a headrest skin material 70 according to Embodiment 4 will be described with reference to FIG. 22. On the back surface of the first skin piece 30, at a position outside the pair of first slits 33 in the direction in which the pair of first slits 33 are aligned, one surface fastener 71 is fixed using a known method such as an adhesive. On the design surface 45 of the seal skin piece 40, at a position outside the pair of second slits 42 in a direction in which the pair of second slits 42 are aligned, the other surface fastener 72 is fixed using a known method such as an adhesive. By engagement between one surface fastener 71 fixed to the first skin piece 30 and the other surface fastener 72 fixed to the seal skin piece 40, the first skin piece 30 and the seal skin piece 40 are engaged.

According to the present embodiment, the seal skin piece 40 and the first skin piece 30 can be engaged by a simple method using the surface fasteners 71 and 72. Accordingly, since the seal skin piece 40 and the first skin piece 30 can be engaged without being sewn together, the second seam 22 is not exposed on the outer surface of the first skin piece 30. As a result, the appearance of the headrest skin material 70 can be improved.

### Embodiment 5

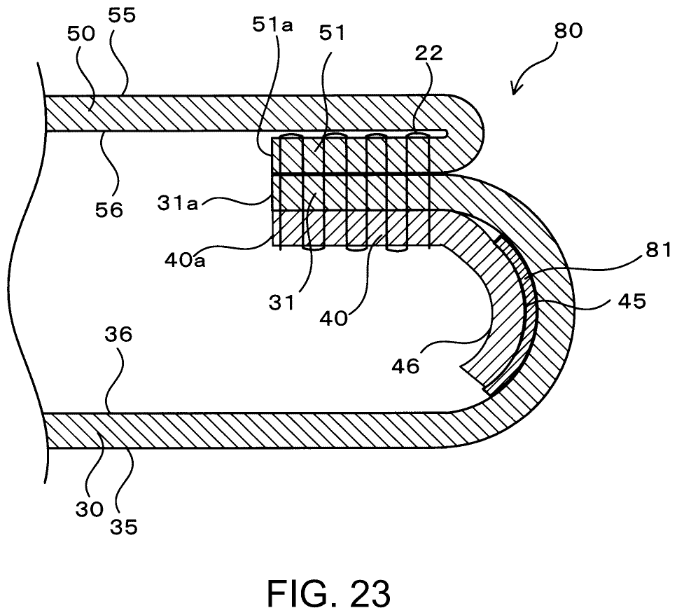

Next, a headrest skin material 80 according to Embodiment 5 will be described with reference to FIG. 23. An area on the back surface of the first skin piece 30 that is outside the pair of first slits 33 in the direction in which the pair of first slits 33 are aligned and an area on the design surface 45 of the seal skin piece 40 that is outside the pair of second slits 42 in the direction in which the pair of second slits 42 are aligned are adhered together by a double-sided tape 81. Accordingly, the first skin piece 30 and the seal skin piece 40 are engaged.

According to the present embodiment, the seal skin piece 40 and the first skin piece 30 can be engaged by a simple method using the double-sided tape 81. Accordingly, since the seal skin piece 40 and the first skin piece 30 can be engaged without being sewn together, the second seam 22 is not exposed on the outer surface of the first skin piece 30. As a result, the appearance of the headrest skin material 80 can be improved.

### Embodiment 6

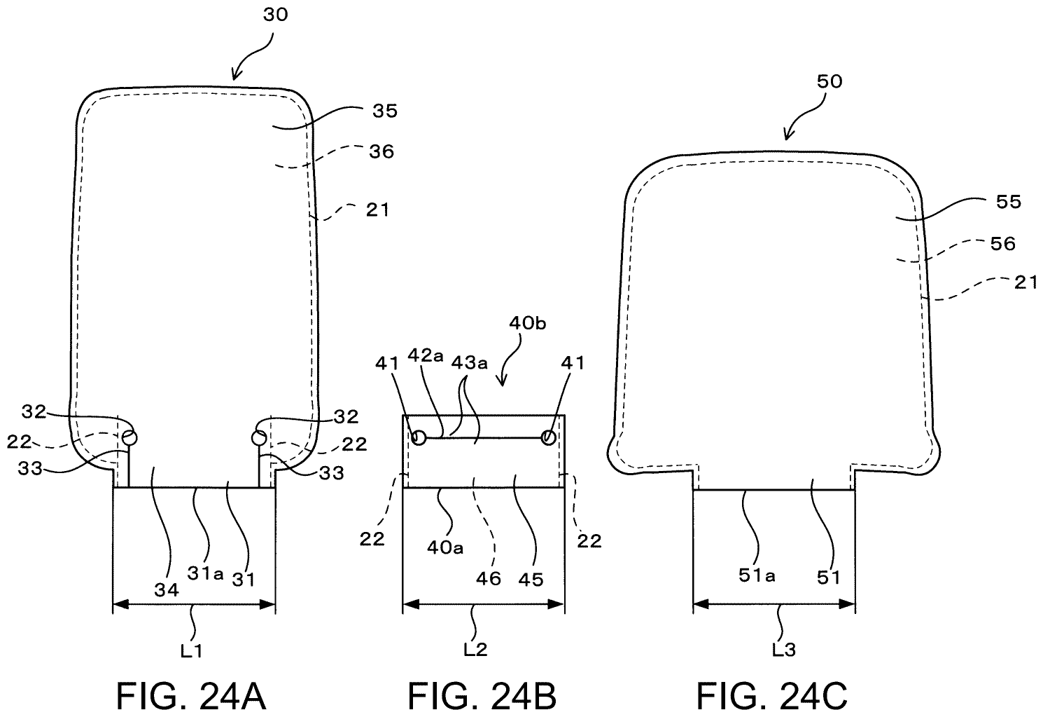

Next, a headrest skin material 90 according to Embodiment 6 will be described with reference to FIG. 24 to FIG. 27.

As shown in FIG. 24, a seal skin piece 40b according to the present embodiment includes a second slit 42a extending from a hole edge of the pair of second insertion holes 41. The second slit 42a is formed at a position between the pair of second insertion holes 41. By the second slit 42a, the pair of second insertion holes 41 are communicated. In a short direction of the seal skin piece 40b, the second slit 42a connects near-central portions of the pair of second insertion holes 41. The second slit 42a is formed to have a width smaller than a span dimension of each of the pair of second insertion holes 41. A pair of second tongue pieces 43a are formed by the hole edges of the pair of second insertion holes 41 and the second slit 42a.

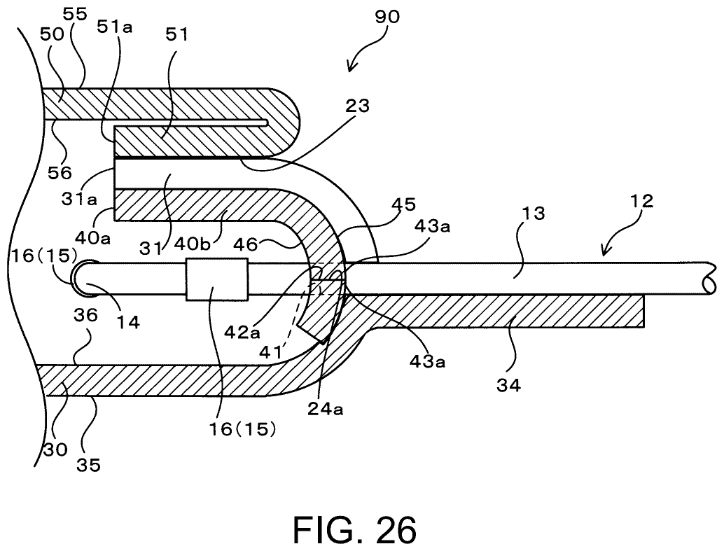

The pair of second tongue pieces 43a are formed to be bendable and deformable. The pair of second tongue pieces 43a can be bent and deformed outward or inward of the headrest skin material 90 independently of each other. By bending and deformation of the pair of second tongue pieces 43a, the inside and outside of the headrest skin material 90 are communicated. Accordingly, the stay 12 can be inserted into the inside of the headrest skin material 90. In this way, the second slit 42a according to the present embodiment is configured as a stay opening 24a for inserting the stay 12 (see FIG. 26).

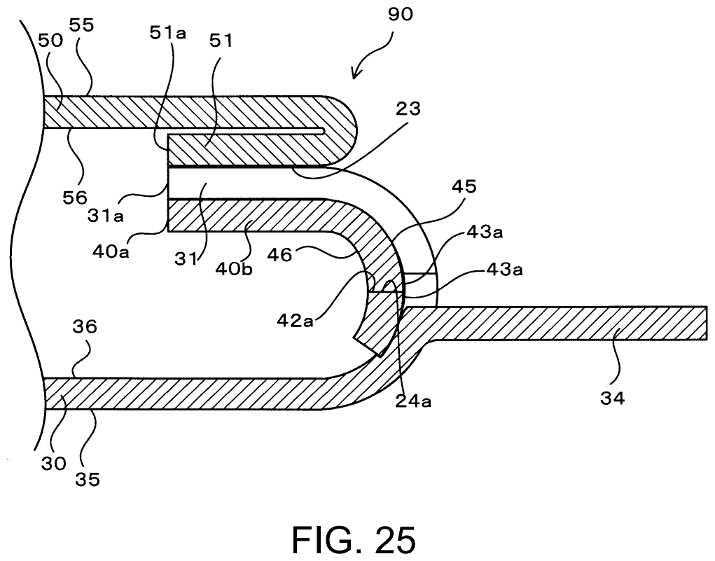

Subsequently, an example of a manufacturing process of the headrest skin material 90 according to the present embodiment will be described with reference to FIG. 25 to FIG. 27.

As shown in FIG. 25, the first tongue piece 34 is pulled outward of the headrest skin material 90. Then, the second slit 42a and the second tongue piece 43a of the seal skin piece 40b are exposed. The second tongue piece 43a is formed to be bendable and deformable. The second slit 42a that is widened by bending and deformation of the second tongue piece 43a serves as the stay opening 24a for inserting the stay 12 into the inside of the headrest skin material 90.

As shown in FIG. 26, regarding an insertion direction of the stay 12 into the headrest skin material 90, the stay 12 is inserted into the inside of the headrest skin material 90 from the stay opening 24a with the connecting part 14 of the stay 12 on the front side.

Although not shown in detail, when the connecting part 14 of the stay 12 comes into contact with the second tongue piece 43a, the second tongue piece 43a is pushed by the stay 12 and bent and deformed, and the connecting part 14 of the stay 12 enters the inside of the headrest skin material 90 from the widened second slit 42a. After the connecting part 14 of the stay 12 passes through the stay opening 24a, the second tongue piece 43a is deformed to return to its original shape. FIG. 26 shows a state after the second tongue piece 43a has been deformed and returned to its original shape.

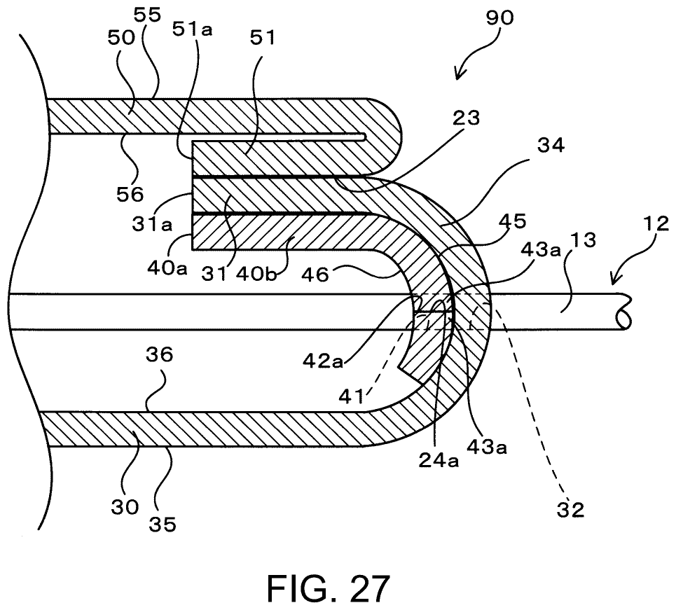

Subsequently, as shown in FIG. 27, the first tongue piece 34 is bent and deformed as a whole, and the first projecting piece 31 is inserted into a gap between the second projecting piece 51 and the seal skin piece 40b to cover the seal skin piece 40b. Accordingly, the stay opening 24a (second slit 42a) is configured to be covered by the first tongue piece 34.

According to the present embodiment, the second slit 42a formed in the seal skin piece 40b is covered from the outside by the first skin piece 30. Thus, even if the foamed resin 17 reaches the second slit 42a, since the first skin piece 30 is present outside the second slit 42a, the leakage of foamed resin 17 to the outside via the second slit 42a can be suppressed.

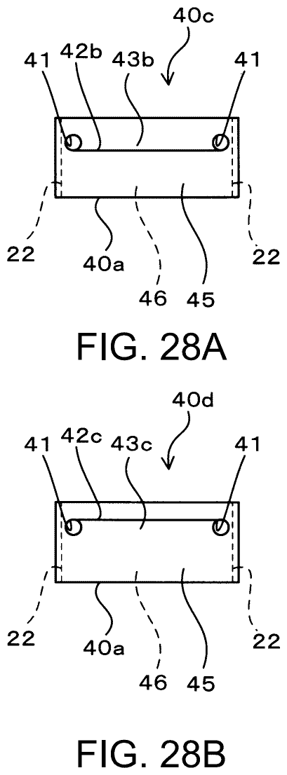

The disclosure is not limited to each of the above embodiments, and can be applied to various embodiments without departing from the gist of the disclosure.
(1) As a structure that engages the first skin piece 30 and the seal skin piece 40, examples such as sewing (Embodiments 1 and 2), pressing with the elastic member 61 (Embodiment 3), the surface fasteners 71 and 72 (Embodiment 4), and the double-sided tape 81 (Embodiment 5) have been illustrated. However, the disclosure is not limited to the above, and any engagement structure may be adopted.
(2) The second slit 42a according to Embodiment 6 is configured to connect the near-central portions of the pair of second insertion holes 41 in the short direction of the seal skin piece 40b. However, the disclosure is not limited thereto. For example, as shown in FIG. 28A, a second slit 42b may be configured to connect the hole edges of the pair of second insertion holes 41 located on one side edge 40a side in the short direction of a seal skin piece 40c. As shown in FIG. 28B, a second slit 42c may be configured to connect the hole edges of the pair of second insertion holes 41 located opposite to one side edge 40a in the short direction of a seal skin piece 40d.

What is claimed is:

1. A headrest skin material (20), obtained by sewing a plurality of skin pieces (30, 40, 50), comprising a bottom (11a) from which a leg (13) of a stay (12) protrudes, wherein
the plurality of skin pieces comprise:
a first skin piece (30), constituting the bottom;
a second skin piece (50), arranged adjacent to the first skin piece; and
a seal skin piece (40), attached to an inner surface of the first skin piece;
a peripheral edge of the first skin piece and a peripheral edge of the second skin piece are configured in a state of being sewn together except for an injection port (23) through which foamed resin (17) is injected;
the first skin piece comprises:
a first projecting piece (31), protruding inward of the headrest skin material from the injection port;
a pair of first insertion holes (32), through which the leg of the stay is inserted;
a pair of first slits (33), extending from the pair of first insertion holes to a tip edge of the first projecting piece; and
a first tongue piece (34), formed by the pair of first slits;
the second skin piece comprises:
a second projecting piece (51), protruding inward of the headrest skin material from the injection port and arranged to face the first projecting piece;
the seal skin piece covers, from inside of the first skin piece, an area on the inner surface of the first skin piece that is wider than an area where the pair of first slits and the pair of first insertion holes are formed, and is engaged at a position on the inner surface of the first skin piece outside the pair of first slits in a direction in which the pair of first slits are aligned;
the seal skin piece comprises:
a pair of second insertion holes (41), provided at a position overlapping the pair of first insertion holes, through which the leg of the stay is inserted;
a second slit (42), extending from the pair of second insertion holes and having a width smaller than a span dimension of the pair of first insertion holes; and
a second tongue piece (43), formed by a hole edge of the pair of second insertion holes and the second slit.

2. The headrest skin material according to claim 1, wherein
the second slit comprises a pair of second slits formed to extend from each of the pair of second insertion holes to an edge opposite to the tip edge of the first projecting piece;
the second tongue piece is formed by the hole edge of the pair of second insertion holes and the pair of second slits; and
a gap formed between the first tongue piece and the second tongue piece in a state in which the first tongue piece is pulled outward and the second tongue piece is bent and deformed is configured as a stay opening for inserting the stay.

3. The headrest skin material according to claim 1, wherein
the second slit (42a, 42b, 42c) is formed between the pair of second insertion holes, and is formed to communicate the pair of second insertion holes;
the second slit is configured as a stay opening for inserting the stay in a state in which the first tongue piece is pulled outward; and
the first tongue piece covers the second slit from outside in a state in which the stay is inserted therein.

4. The headrest skin material according to claim 1, wherein
one side edge (40a) of the seal skin piece is formed to have a length dimension equal to a width dimension of the first projecting piece in a direction intersecting a protrusion direction of the first projecting piece; and
the one side edge of the seal skin piece is arranged to coincide with the tip edge (31a) of the first projecting piece.

5. The headrest skin material according to claim 1, wherein,
at a position outside the pair of first slits in the direction in which the pair of first slits are aligned on the inner surface of the first skin piece, the seal skin piece is engaged with the inner surface of the first skin piece at least from a portion overlapping the tip edge of the first projecting piece to a portion overlapping an area where the pair of first insertion holes are formed.

6. The headrest skin material according to claim 5, wherein,
at a position outside the pair of first slits in the direction in which the pair of first slits are aligned on the inner surface of the first skin piece, the seal skin piece is engaged with the inner surface of the first skin piece from the portion overlapping the tip edge of the first projecting piece to an edge facing away from the tip edge of the first projecting piece.

7. The headrest skin material according to claim 5, wherein
the first skin piece and the seal skin piece are engaged by being sewn together.

8. The headrest skin material according to claim 7, wherein
a portion of a sewn portion between the first skin piece and the seal skin piece serves as a sewn portion between the first skin piece and the second skin piece.

9. The headrest skin material according to claim 5, further comprising:
on a surface of the seal skin piece opposite to the first skin piece, an elastic member (61) that is elastically deformable and is fixed at a position outside the pair of first slits in the direction in which the pair of first slits are aligned, wherein
the seal skin piece is engaged with a back surface of the first skin piece by the seal skin piece being pressed against the first skin piece by an elastic force of the elastic member.

10. The headrest skin material according to claim 5, further comprising:
on a surface of the seal skin piece opposite to the first skin piece, a reinforcing member (62) that is elastically deformable and is fixed in an area overlapping the first tongue piece.

11. The headrest skin material according to claim 5, further comprising:
a surface fastener (71, 72), fixed to opposing surfaces of the seal skin piece and the first skin piece, wherein the seal skin piece and the first skin piece are engaged by the surface fastener.

12. The headrest skin material according to claim 5, further comprising:
a double-sided tape (81), adhered to one of opposing surfaces of the seal skin piece and the first skin piece, wherein
the seal skin piece and the first skin piece are engaged by the double-sided tape.

13. The headrest skin material according to claim 4, wherein
the seal skin piece is formed in a rectangular shape with a side edge that is arranged to coincide with the tip edge of the first projecting piece being configured as one of a pair of long sides.

14. A headrest (10), comprising:
the headrest skin material according to claim 1;
a stay, on which a structure is arranged at a portion arranged inside the headrest skin material, and through which the leg is inserted from the pair of first insertion holes and the pair of second insertion holes; and
foamed resin, filled inside the headrest skin material.
